(19) United States
(12) Patent Application Publication
(10) Pub. No.: US 2004/0226563 A1
(43) Pub. Date: Nov. 18, 2004

(54) Face Mask with Double Breathing Chambers

(76) Inventors: Zhaoxia Xu, Ypsilanti, MI (US); Zheng Peng, Ypsilanti, MI (US)

Correspondence Address: ZHAOXIA XU, 4694 SYCAMORE DR., YPSILANTI, MI, 48197, US

(21) Appl. No.: 10/249,832

(22) Filed: May 12, 2003

(51) Int. Cl. A62B 18/08; A62B 18/02

(52) U.S. Cl. 128/206.21; 128/206.23

(57) ABSTRACT

A face mask (100) with double breathing chambers. Face mask (100) includes an outer face piece (102) for covering the nose, mouth and eyes of a wearer, an inner face piece (104) for covering the nose and mouth of the wearer, a separation piece (06, made of a substantially impermeable material, substantially dividing face piece (04) into a nose portion (104a) and a mouth portion (104b), thereby forming a nose chamber and a mouth chamber, such that gas communication between the two chambers is minimized, an exhalation device (108) for allowing air to pass therethrough from an interior gas space to an exterior gas space, an inhalation device (110) for allowing air to pass therethrough from an exterior gas space to an interior gas space, and a lens (112) for allowing the wearer to watch therethrough. In another embodiment of the present invention, face mask (200) includes a face piece (202), made of a filtration material, a separation member (204), made of a substantially impermeable material, substantially dividing face piece (202) into a nose portion (202a) and a mouth portion (202b), thereby forming a nose chamber and a mouth chamber, such that gas communication between the two chambers is minimized. The face mask of the present invention is more comfortable and hygienic to wear compared with prior art products. This invention has utility with many types of face masks, including medical, clean-room, firefighting, chemical-biological applications, etc.

### BACKGROUND OF INVENTION

This invention generally relates to face masks. More specifically, this invention relates to face masks with double breathing chambers.

Face masks that have been designed to protect the wearer are commonly referred to as “respirators”, whereas masks that have been designed primarily to protect other persons and things are generally referred to as “face masks” or simply “masks”. In this invention disclosure, they are generally termed as “face masks” or simply “masks”.

People wear masks for two common purposes: (1) to prevent contaminants from entering the wearer's respiratory system; and (2) to protect others from being exposed to pathogens and other contaminants exhaled by the wearer.

It is believed that comfortable masks are much more likely to be worn and therefore are more beneficial from a safety standpoint. Safety of the wearer and others is a primary concern in mask development.

Some masks are categorized as “disposable”, because they are used for relatively short time periods and discarded thereafter. These masks are typically, made from non-woven fibrous webs. However, fibers that protrude from the web have caused discomfort to its wearer by creating a tickling sensation. Disposable masks generally fall into two different categories, namely, fold-flat masks and molded masks. Fold-flat masks are packed flat but are formed with seams, pleats and/or folds that enable them to be opened into a cup-shaped configuration. Molded masks, however, are preformed into a desired face-fitting configuration and generally retain that configuration during use.

Molded masks are commonly made from thermally bonding fibers. Thermally bonding fibers bond to adjacent fibers after being heated and cooled. These face masks are cup-shaped ones that have at least one layer of thermally bonding fibers. The layer of thermally bonding fibers is termed a “shaping layer”, and is used to provide a shape to the mask and support for one or multiple filtration layers. The shaping layer may reside on an inner portion of the mask (adjacent to the face of the wearer), or it may reside on an outer portion or in the middle of multiple filtration layers.

In some cases, all of the layers of materials are assembled together before the shaping layer is molded so that all of the layers are subjected to the molding procedure. In other cases, only the material for the shaping layer is molded and the other layers are applied afterwards.

Other masks are categorized as “non-disposable”, because they are used repeatedly. After each use they are decontaminated (cleaned), with/without some part exchanges. These masks are typically made from multi-layer fabrics, e.g., some surgical masks, or of semi-rigid and impermeable materials, e.g., full-face and half-face masks including firefighter masks and chemical-biological masks. The latter is usually more advanced than most of the aforementioned ones.

Intensive research has been directed toward mask development for various applications. Many patents have been granted.

U.S. Pat. No. 5,803,075, issued to Yavitz, on Sep. 8, 1998, describes a flat surgical mask for covering the nose and mouth of a wearer.

U.S. Pat. No. 4,384,577, issued to Huber, et al., on May 24, 1983, describes a molded face mask for filtering air.

U.S. Pat. No. 6,041,782, issued to Angadjivand, et al., on Mar. 28, 2000, describes a molded respiratory mask comprising a molded, cup-shaped, shape-retaining shell.

U.S. Pat. No. 6,460,539, issued to Japuntich, et al., on Oct. 8, 2002, describes a respirator that includes an integral filter element, an exhalation valve, and impactor element.

U.S. Pat. No. 6,116,239, issued to Grove, et al., on Jan. 23, 2001, describes an advanced chemical-biological mask for protecting a wearer from chemical and biological environmental contaminants.

U.S. Pat. No. 4,419,993, issued to Petersen, on Dec. 13, 1983, describes a surgical mask comprising a face piece divided into an upper region and a lower region. The lower region is more permeable. The face mask may be suitably worn by eye-glass clad operation room staff members since exhaled air is directed downward away from the eyes of the wearer of the mask.

A big issue associated with wearing a mask is the discomfort it causes to the wearer. This discomfort is caused by the warm, humid, high-carbon-dioxide exhaled air resides inside the mask interior gas space and within filtration materials during exhalation. The situation gets even worse for people who have to wear masks for pro-longed periods of time, such as clean-room workers, operation-room doctors and nurses, patients suffering from extremely contagious respiratory diseases, like SARS, firefighters in fighting fire disasters, and soldiers in chemical and biological battle fields.

Based on the inventors' investigation/observation, a person's breathing includes two primary activities, namely, inhalation and exhalation. There is a brief pause in between. Inhalation is not causing discomfort to the wearer so long as the resistance of the filtration material to the air going through the face mask is small. Through innovative designs, especially proper selections of filtration materials, discomfort caused by inhalation has been minimized. The primary discomfort associated with wearing a face mask comes from exhalation. The warm and humid exhaled air and the high-carbon-dioxide content in it is the identified root cause. The exhaled air fills the whole interior gas space during exhalation and causes discomfort and re-inhalation of the residual exhaled air.

It is ideal to purge all the exhaled air out of the face mask before next inhalation. However, even the most advanced face masks fails to achieve this target. Research work has been concentrating on facilitating exhalation by providing valves to reduce the resistance pressure required for propelling the exhalation air out of the mask. Most non-medical masks, like firefighter and chemical-biological masks, fall in this category. For face masks of medical use, U.S. Pat. No. 6,460,539 discloses a valved face mask with a filter.

Unfortunately, residual exhalation air trapped inside the area enclosed by the mask and the wearer' face remains therein. The larger the enclosed space therein, the more residual exhaled air. Re-inhalation of this residual exhaled air is causing discomfort to the wearer and it is not healthy/hygienic, especially for the people suffering from extremely contagious respiratory diseases, such as SARS. These patients are generally required to wear masks due the extremely contagious nature of the disease.

However, even the resistance or pressure drop required to propel the exhalation air has been minimized to a minimal level, completely purging the exhalation air by the wearer is still out of the question. This is due to the fact that the exhalation air trapped inside the enclosed space formed by the face mask and its wearer' face and within the filtration materials cannot be purged by the wearer without outside help.

There are two approaches for tackling the issue of discomfort and re-inhalation of residual exhaled air associated with wearing a face mask, 1) directing the exhalation air in a controlled manner to a smaller and less sensitive area to minimize the discomfort and to avoid re-inhalation of the residual exhaled air; or 2) bringing in outside help namely, a device to remove it. This invention disclosure is taking the former approach.

Therefore, it remains desirable to provide a face mask, which can (i) prevent contaminants from passing from the wearer to the ambient air; (ii) prevent contaminants from passing from the ambient air to the wearer; (iii) prevent splash-fluids from entering the mask interior; (iv) allow warm, humid, high-carbon-dioxide air to be quickly purged from the mask's interior gas space; and (v) direct the exhalation air in a controlled manner to a smaller and less sensitive area for avoiding/minimizing the discomfort to the wearer and the re-inhalation of the residual air trapped inside the mask interior gas space and within the filtration materials.

### SUMMARY OF INVENTION

Accordingly, the present invention is a face mask. This face mask comprises an outer face piece covering the nose, mouth and eyes of a wearer, a inner face piece covering the nose and mouth, a separation piece, made of a substantially impermeable material, substantially dividing the inner face piece into a nose portion and a mouth portion, thereby, forming a nose chamber and a mouth chamber, such that the gas communication between the two chambers is minimized, an exhalation device for allowing exhalation air to pass from an interior gas space to an exterior gas space during an exhalation, an inhalation device for allowing air to pass from an exterior gas space to an interior gas space during inhalation, a lens for allowing the wearer to watch therethrough, and an adjustable and/or elastic strap for tightening the face mask against the wearer's face.

In another embodiment of this present invention, this face mask comprises a face piece covering the nose and mouth of a wearer, a separation piece, made of a substantially impermeable material, substantially dividing the face piece into a nose portion and a mouth portion, thereby, forming a nose chamber and a mouth chamber, such that the gas communication between the two chambers is minimized, an exhalation device for allowing exhalation air to pass from an interior gas space to an exterior gas space during an exhalation, an inhalation device for allowing air to pass from an exterior gas space to an interior gas space during inhalation, and an adjustable and/or elastic strap for tightening the face mask against the wearer's face.

In an further more embodiment of the present invention, this face mask comprises a face piece, made of a permeable filtration material, covering at least the nose and mouth of a wearer, a separation member, made of a substantially impermeable material, substantially dividing the face piece into a nose portion and a mouth portion, thereby, forming a nose chamber and a mouth chamber, such that the gas communication between the two chambers is minimized, and an adjustable and/or elastic strap for tightening the face mask against the wearer's face.

Accordingly, the followings are some of the objects, features, and advantages of the present invention:

It is an object of the present invention to provide a face mask that prevents contaminants from entering the wearer's respiratory system.

It is another object of the present invention to provide a face mask that protects others from being exposed to pathogens and other contaminants exhaled by the wearer.

It is a further more object of the present invention to provide a face mask that minimizes the discomfort and fogging of eyeglasses associated with wearing a face mask and avoids the re-inhalation, by the wearer, of the residual exhaled air trapped inside the enclosed space and within the filtration materials, whereby the face mask of the present invention is more comfortable and hygienic to wear.

It is a still further more object of the present invention to provide a face mask that more efficiently utilizes filtration materials and has longer utility life by having different filtration materials for inhalation and exhalation, respectively.

It is a feature of the present invention that this face mask has a substantially impermeable separation member substantially dividing the face piece into a nose portion and a mouth portion, thereby, forming a nose chamber and a mouth chamber, such that the gas communication between the two chambers is minimized and such that exhalation air can be directed to the mouth chamber, whereby the re-inhalation of residual exhaled air is totally eliminated.

It is an advantage of the present invention that this face mask directs the exhalation air to the mouth portion, thereby minimizing the area size irritated by the warm and humid exhaled air.

It is another advantage of the present invention that this face mask totally eliminated the possibility of re-inhalation of residual exhaled air by the wearer, whereby it is comfortable and hygienic to wear.

It is a further more advantage of the present invention that this face mask is beneficial to the people who wears glasses. By directing exhaled air in a controlled manner and to a specific area, fogging of glasses is minimized.

Further more features and advantages of the present invention will be readily appreciated, as the same becomes better understood after reading the subsequent description when considered in connection with the accompanying drawings.

### BRIEF DESCRIPTION OF DRAWINGS

FIG. 1 illustrates an embodiment of the present invention, a full-face face mask 100 covering the wearer's nose, mouth, and eyes.

FIG. 2 illustrates a cross-sectional view of face mask 100, taken along line A-A of FIG. 1.

FIG. 3 illustrates a cross-sectional view of exhalation device 108, for an alternative design.

FIG. 4 illustrates a cross-sectional view of inhalation device 170, taken along line B-B of FIG. 1.

FIG. 5 illustrates another embodiment of the present invention, a half-face face mask 150 covering the wearer's nose and mouth.

FIG. 6 illustrates a cross-sectional view of face mask 150, taken along line A-A of FIG. 5.

FIG. 7 illustrates a cross-sectional view of exhalation device 156, for an alternative design.

FIG. 8 illustrates a cross-sectional view of inhalation device 158, taken along line B-B of FIG. 5.

FIG. 9 illustrates a further more embodiment of the present invention, a molded face mask 200 covering the wearer's nose and mouth.

FIG. 10 illustrates a cross-sectional view of face mask 200, taken along line A-A of FIG. 9.

FIG. 11 illustrates a perspective view of face mask 200, viewing from the back, indicating a design of separation member 204.

FIG. 12 illustrates a perspective view of face mask 200, viewing from the back, indicating an alternative design of separation member 204.

FIG. 13 illustrates a cross-sectional view of a design of separation member 204 joining face piece 202.

FIG. 14 illustrates a cross-sectional view of an alternative design of separation member 204 joining face piece 202.

FIG. 15 illustrates a cross-sectional view of another alternative design of separation member 204 joining face piece 202.

FIG. 16 illustrates a cross-sectional view of a further more alternative design of separation member 204 joining face piece 202.

FIG. 17 illustrates a front view of an alternative design of face mask 200 of FIG. 9.

FIG. 18 illustrates a still further more embodiment of the present invention, a fold flat face mask 210 covering the wearer's nose and mouth.

FIG. 19 illustrates a perspective view of face mask 210 on a wearer.

FIG. 20 illustrates a cross-sectional view of face mask 210, taken along line A-A of FIG. 18, but on a wearer at a working position.

FIG. 21 illustrates a perspective view of face mask 210, viewing from the back, indicating a design of separation member 214.

FIG. 22 illustrates a perspective view of face mask 210, viewing from the back, indicating an alternative design of separation member 214.

### DETAILED DESCRIPTION

This invention has utility with many types of face masks, including half masks that cover the wearer's nose and mouth; full face masks that cover the wearer's nose, mouth, and eyes; full body suits and hoods that supply clean air to a wearer; powered and supplied air masks; self-contained breathing apparatus; and essentially any other face masks.

The face mask of the present invention requires its wearer to inhale with the nose and exhale with the mouth, such that the two breathing activities take place in two separated chambers and the discomfort associated with wearing face masks is minimized. However, the wearer has the choice of breathing using his/her nose only, as using a conventional face mask, with less comfort.

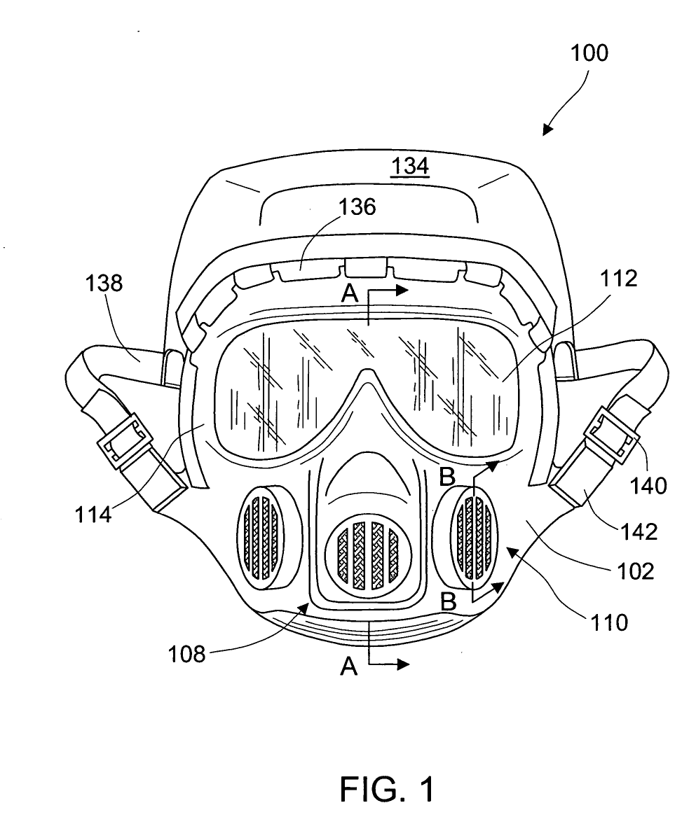

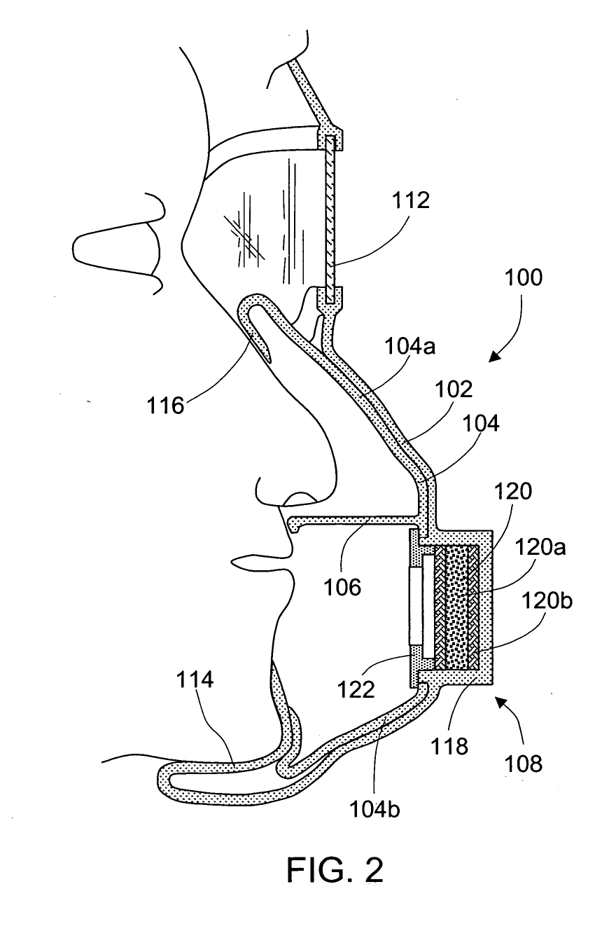

Reference is made to FIGS. 1 and 2, which illustrate an embodiment of the present invention, a full-face face mask 100 covering the nose, mouth, and eyes of a wearer. FIG. 1 illustrates a front view of face mask 100 and FIG. 2 illustrates a cross-sectional view of face mask 100, taken along line A-A of FIG. 1. Face mask 700 comprises an outer face piece 102, an inner face piece 104, a separation piece 106, an exhalation device 108, an inhalation device 110, and a lens 112.

Face piece 102, which is designed to be conformal to the face and is made of a semi-rigid but flexible silicone hybrid or fluorosilicone material. Although other silicone and organic rubber materials can be used (for example silicone rubber, EPDM, butyl rubber, thermoplastic elastomer), the silicone hybrid and fluorosilicone materials are preferred and have been selected because of their flexibility. Other materials can be used for low weight and low cost products, such as partially made of molded plastic or polymer materials.

An in-turned (rolled periphery) flexible face seal 114 is provided around the entire outer edge of face piece 102 and has an integrally molded feature thereof. Seal 114 is intended to come into contact with the face of the wearer, and is contoured to conform to and form a leak-free seal with the wearer's face.

Inner face piece 104 is adapted to fit within face piece 102 and designed to be conformal to the face covering the nose and mouth. Inner face piece 104 is, preferably, made of the same material as face piece 102. Face piece 104 can be a separate part installed inside face piece 102 or can be an integral portion of face piece 102. Face piece 104 has a rolled flange seal 116, disposed at the open portion thereof, sealing around the nose and adjacent facial area of the wearer.

Separation piece 106 is provided for substantially dividing inner face piece 104 into a nose portion 104a and a mouth portion 104b, thereby forming a nose chamber and a mouth chamber, such that the gas communication between the two chambers is minimized and such that inhalation air stream and exhalation air stream can be separated to avoid inhalation, by the wearer, of the residual warm, humid, and carbon dioxide rich exhaled air trapped inside the interior gas space, whereby face mask 100 is comfortable and hygienic to wear. Separation piece 106 can be a separate part installed inside face piece 104 or an integral portion thereof. The first end of separation piece 106 is attached on the inner surface of face piece 104 and the second end thereof extends rearward toward the wearer's facial area in between the nose and mouth, across/around the cheek areas close to the mouth. Separation piece 106 is intended to come into contact with and is contoured to conform to the wearer's face around the mouth and can have an open feature or a closed feature encompassing the mouth.

Separation piece 106 is made of a substantially impermeable and, preferably, semi-rigid material similar to those for face pieces 102 and 104, and any other suitable materials known to those skilled in the art and suggested by this invention disclosure.

Exhalation device 108 comprises a filter housing 118, filter medium 120, and a filter cap 122.

Housing 118 is molded to face piece 102 so that material of face piece 102 surrounds the edges of housing 118. There are open slots on the front surface of housing 118 for permitting the wearer to exhale. Filter medium 120 is disposed within housing 118. Filter medium 120 includes an activated carbon filter 120a and a particulate filter 120b. Filter 120b, preferably, comprises two layers sandwiching filter 120a. Filter cap 122 is provided for holding filter medium 120 in position. There is a central aperture on filter cap 122 for allowing the wearer to exhale therethrough.

Filter 120a is, preferably, made from a moldable carbon bed. Typically, filter 120a is made by bonding activated carbon granules using a thermoplastic binder material, such as polyurethane, thereby immobilizing the carbon granules in the bed. The bonding ratio (typically 5-15% polymer to carbon granules) is optimized for both ruggedness and vapor absorption performance.

On the other hand, particulate filter 120b is typically made from a thermally molded fibrous material or an electrostatic material for more advanced applications. Particulate filter 120b generally includes a shell layer for moisture protection.

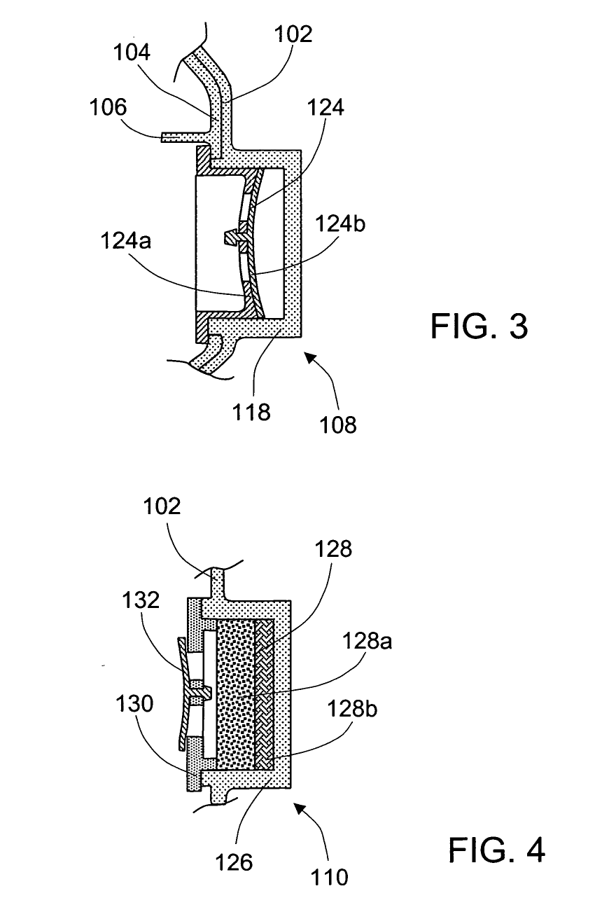

FIG. 3 illustrates an alternative design of exhalation device 108. In this design filter medium 120 is replaced with a valve 124, as is widely used in many non-medical applications. Valve 124 permits exhaled air to pass therethrough but will close up during inhalation. Valve 124 includes a valve body 124a, which has openings thereon allowing exhaled air to pass therethrough, and a diaphragm member 124b, which is in a closed position closing up the openings on valve body 124a. During exhalation, the increased pressure inside the mouth chamber will deform diaphragm member 124b outboard, such that valve 124 is in an open position. A tapered portion is integral with diaphragm member 124b and snaps into a suitable aperture in valve body 124a, whereby, diaphragm member 124b can be removed or replaced if desired.

Exhalation device 108 can be further alternatively designed (not shown) such that it includes both filter 120 and valve 124, as known in prior arts, whereby face mask 100 can protect other persons or things from being exposed to contaminants expelled by the wearer, as compared with the valve-only design. This design can have medical, clean room, and many other applications.

FIG. 4 illustrates a cross-sectional view of inhalation device 110, taken along line B-B of FIG. 1. Inhalation device 110 comprises a filter housing 126, filter medium 128, a filter cap 140, and a valve 142.

Housing 126 is molded to face piece 102 so that material of face piece 102 surrounds the edges of housing 126. There are open slots on the front surface of housing 126 for permitting the wearer to inhale. Filter medium 128 is disposed within housing 126. Filter medium 128 includes an activated carbon filter 128a and a particulate filter 128b. Filters 128a and 128b possess the same characteristics as filters 120a and 120b, respectively, of FIG. 2. Filter cap 140 is provided for holding filter medium 128 in position. There is a central aperture on filter cap 140 for allowing the wearer to inhale therethrough. Valve 142 is provided for permitting filtered air to pass therethrough but will close up during exhalation, such that no exhalation air passes therethrough.

There are apertures (not shown) on inner face piece 104 inline with inhalation device 110 for permitting filtered air to pass therethrough to the wearer's nose. A plurality of air conduits (not shown) can be provided in between face pieces 102 and 104 for directing filtered air passing therethrough to the vicinity of eye lens 112 first before going into inner face piece 104 for defogging lens 112.

Reference is made to FIG. 1, again. Single-piece eye lens 112, which is semi-flexible and conforms to the facial structure of the wearer, is molded or integrally bonded directly into face piece 102 using a silicone adhesive. Lens 112 is made of a polycarbonate or a polyurethane material, and coated with silicate, acrylic, or polyurethane formulations to provide scratch resistance. Lens 112 is designed with a polynomial curvature for optimum eye relief (25 millimeter) and visibility while having ample space for an optical correction spectacle (not shown).

Face piece 102 is attached to a crown portion 144 via a plurality of suspension flanges, generally designated as 146, and a suspension device (not shown). A pair of elastic straps 148, which are made from any material of sufficient elasticity, are connected to opposite sides at the rear of crown portion 144 as by stitching. Straps 138 are adjustably connected as by stitching to buckles 140, which are connected to tabs 142 molded to face piece 102.

Face mask 100 requires its wearer to inhale with the nose and exhale with the mouth. However, the wearer has the choice of exhaling with the nose, as using a conventional face mask. In this case, a one-way valve (not shown) can be provided in between the nose chamber and the mouth chamber for permitting the exhaled air to pass therethrough from the nose chamber to the mouth chamber and then to pass through exhalation device 108 to an exterior gas space.

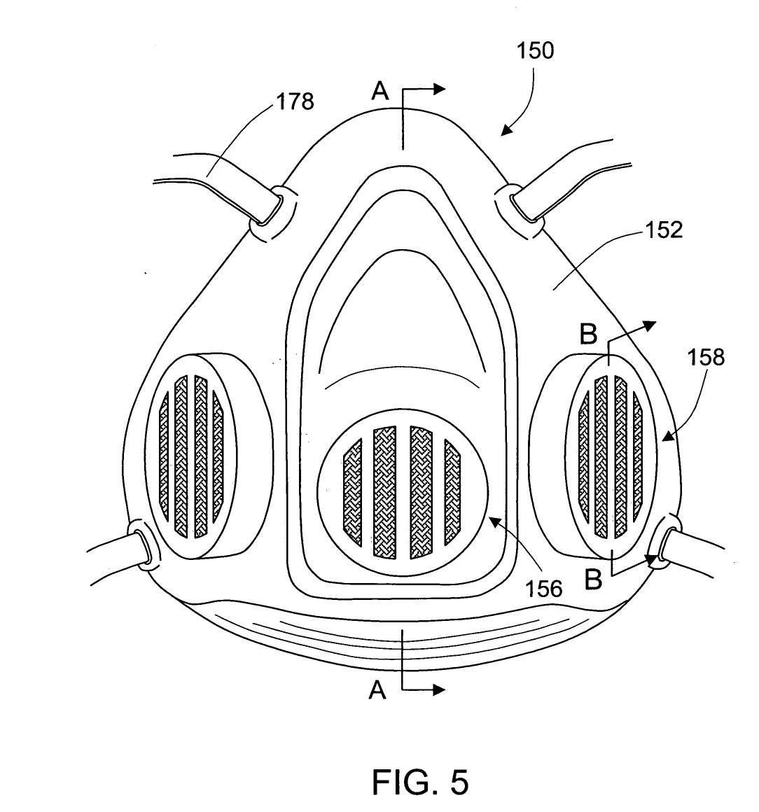

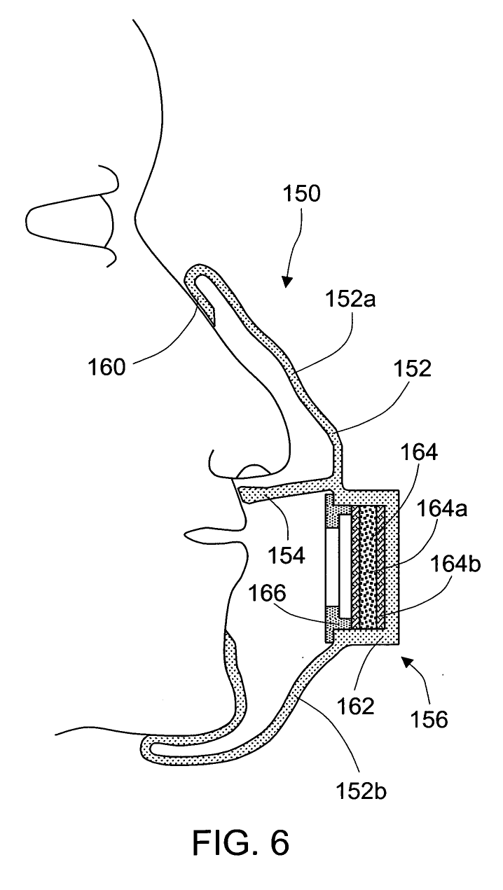

Reference is, now, made to FIGS. 5 and 6, which illustrate another embodiment of the present invention, a half-face face mask 150 covering the nose and mouth of a wearer. FIG. 5 illustrates a front view of face mask 150 and FIG. 6 illustrates a cross-sectional view of face mask 150, taken along line A-A of FIG. 5. Face mask 150 comprises a face piece 152, a separation piece 154, an exhalation device 156, and an inhalation device 158.

Face piece 152, which is designed to be conformal to the face and is made of a semi-rigid but flexible silicone hybrid or fluorosilicone material. Although other silicone and organic rubber materials can be used (for example silicone rubber, EPDM, butyl rubber, thermoplastic elastomer), the silicone hybrid and fluorosilicone materials are preferred and have been selected because of their flexibility. Other materials can be used for low weight and low cost products, such as partially made of molded plastic or polymer materials.

An in-turned (rolled periphery) flexible face seal 160 is provided around the entire outer edge of face piece 152 and has an integrally molded feature thereof. Seal 160 is intended to come into contact with the face of the wearer, and is contoured to conform to and form a leak-free seal with the wearer's face.

Separation piece 154 is provided for substantially dividing face piece 152 into a nose portion 152a and a mouth portion 152b, thereby forming a nose chamber and a mouth chamber, such that the gas communication between the two chambers is minimized and such that inhalation air stream and exhalation air stream can be separated to avoid inhalation, by the wearer, of residual warm, humid, and carbon dioxide rich exhaled air trapped inside the interior gas space, whereby face mask 150 is comfortable and hygienic to wear. Separation piece 154 can be a separate part installed inside face piece 152 or an integral portion thereof. The first end of separation piece 154 is attached on the inner surface of face piece 152 and the second end thereof extends rearward toward the wearer's facial area in between the nose and mouth, across/around the cheek areas close to the mouth. Separation piece 154 is intended to come into contact with and is contoured to conform to the wearer's face around the mouth and can have an open feature or a closed feature encompassing the mouth.

Separation piece 154 is made of a substantially impermeable and, preferably, semi-rigid material similar to those for face piece 152, and any other suitable materials known to those skilled in the art and suggested by this invention disclosure.

Exhalation device 156 comprises a filter housing 162, filter medium 164, and a filter cover 166.

Housing 162 is molded to face piece 152 so that material of face piece 152 surrounds the edges of housing 162. There are open slots on the front surface of housing 162 for permitting the wearer to exhale. Filter medium 164 is disposed within housing 162. Filter medium 164 includes an activated carbon filter 164a and a particulate filter 164b. Filter 164b preferably comprises two layers sandwiching filter 164a. Filter cap 166 is provided for holding filter medium 164 in position. There is a central aperture on filter cap 166 for allowing the wearer to exhale therethrough.

Filter 164a is, preferably, made from a moldable carbon bed. Typically, filter 164a is made by bonding activated carbon granules using a thermoplastic binder material, such as polyurethane, thereby immobilizing the carbon granules in the bed. The bonding ratio (typically 5-15% polymer to carbon granules) is optimized for both ruggedness and vapor absorption performance.

On the other hand, particulate filter 164b is typically made from a thermally molded fibrous material or an electrostatic material for more advanced applications. Particulate filter 164b generally includes a shell layer for moisture protection.

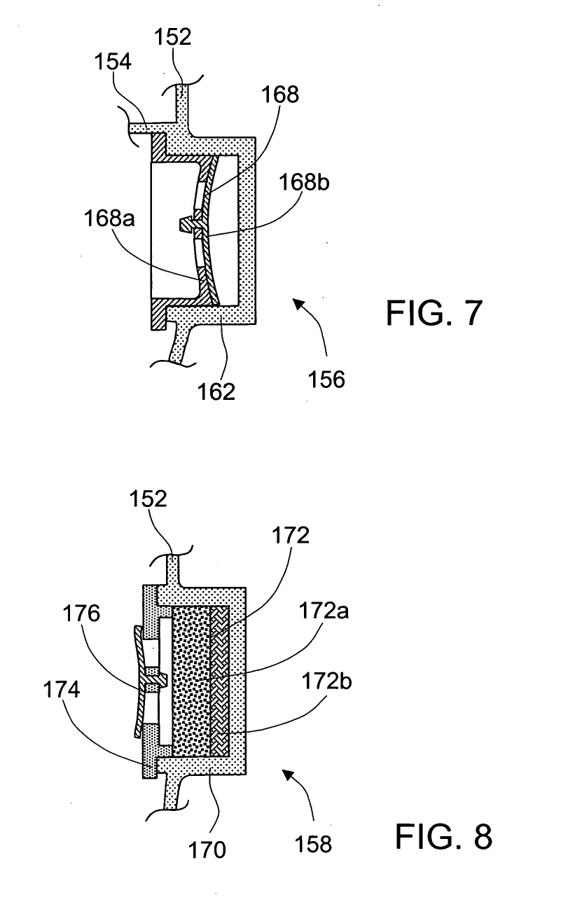

FIG. 7 illustrates a cross-section view of an alternative design of exhalation device 156. In this design filter medium 164 is replaced with a valve 168, as is widely used in many non-medical applications. Valve 168 permits exhaled air to pass therethrough but will close up during inhalation. Valve 168 includes a valve body 168a, which has openings thereon for allowing exhaled air to pass therethrough, and a diaphragm member 168b, which is in a closed position closing up the openings on valve body 168a. During exhalation, the increased pressure inside the mouth chamber will deform diaphragm member 168b outboard, such that valve 168 is in an open position. A tapered portion is integral with diaphragm member 168b and snaps into a suitable aperture in valve body 168a, whereby, diaphragm member 168b can be removed or replaced if desired.

Exhalation device 156 can be further alternatively designed (not shown) such that it includes both filter 164 and valve 168, as known in prior arts, whereby face mask 150 can protect other persons or things from being exposed to contaminants expelled by the wearer, as compared with the valve-only design. This design can have medical, clean room and many other applications.

Reference is made to FIG. 8, which illustrates a cross-sectional view of inhalation device 158, taken along line B-B of FIG. 5. Inhalation device 158 comprises a filter housing 110, filter medium 112, a filter cap 114, and a valve 116.

Housing 110 is molded to face piece 152 so that material of face piece 152 surrounds the edges of housing 110. There are open slots on the front surface of housing 110 for permitting the wearer to inhale. Filter medium 112 is disposed within housing 110. Filter medium 112 includes an activated carbon filter 112a and a particulate filter 112b. Filters 112a and 112b possess the same characteristics as filters 120a and 120b, respectively, of FIG. 2. Filter cap 114 is provided for holding filter medium 112 in position. There is a central aperture on filter cap 114 for allowing the wearer to inhale therethrough. Valve 116 is provided for permitting filtered air to pass therethrough but will close up during exhalation, such that no exhalation air passes therethrough.

Reference is made to FIG. 5, again. A pair of elastic straps, generally designated as 118, which are made from any material of sufficient elasticity, are provided for holding face mask 150 against the wearer's face.

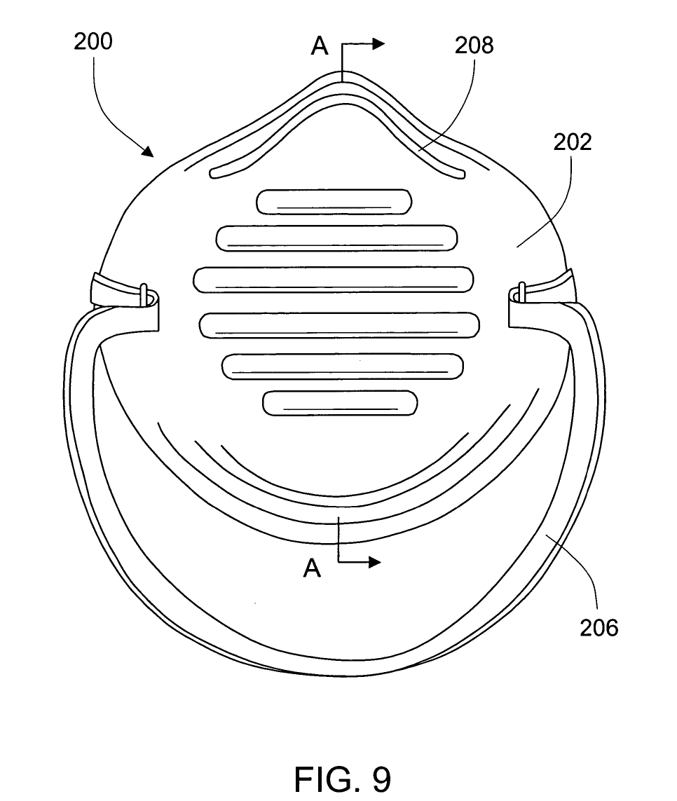

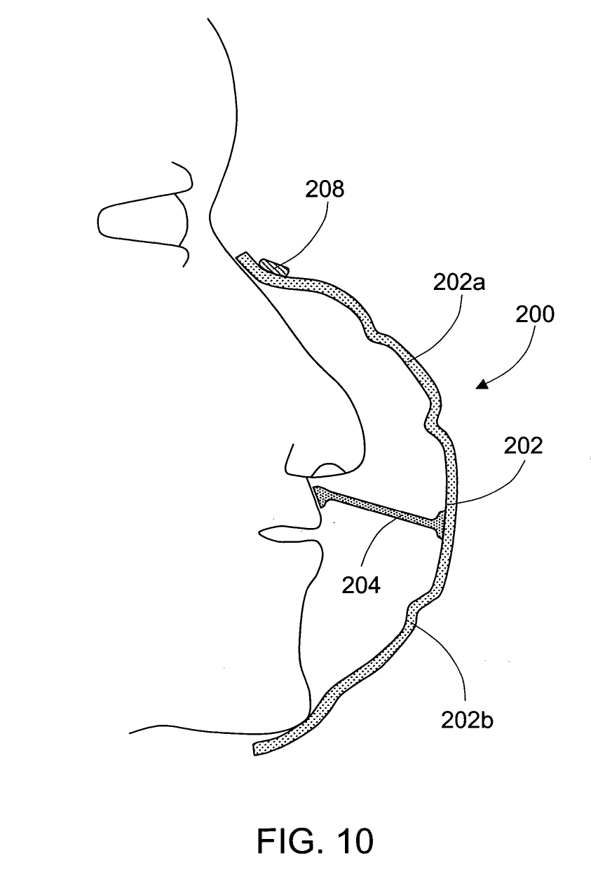

Reference is made to FIGS. 9 and 10, which illustrate an alternative embodiment of the present invention, a molded face mask 200 covering the wearer's nose and mouth. FIG. 9 illustrates a front view of face mask 200. FIG. 10 illustrates a cross-sectional view of face mask 200, taken along line A-A of FIG. 9.

Face mask 200 comprises a face piece 202, a separation member 204, an elastic head band 206, and a nose clip 208.

Face piece 202 has a generally cup-shaped, face-fitting configuration. The periphery of face piece 202 is shaped to contact the face of the wearer over the bridge of the nose, across and around the cheeks, and under the chin. Face piece 202 then forms an enclosed space around the nose and mouth of the wearer.

Face piece 202 is made from a plurality of layers including a thermally bonding fibers layer and some filtration layers. Thermally bonding fibers bond to adjacent fibers after being heated and cooled. These thermally bonding fibers form a generally cup-shaped shape-retaining layer. A plurality of filtration layers can be applied thereon. Face piece 202 is formed from a plurality of layers of material selected to ensure that it has a degree of flexibility to enable it to fit to the face of the wearer while being stiff enough to retain its shape during use. An optional corrugated pattern extends through all the layers of the central region of face piece 202.

Separation member 204 substantially divides face piece 202 into a nose portion 202a and a mouth portion 202b, thereby forming a nose chamber and a mouth chamber, such that the gas communication between the two chambers is minimized and such that inhalation air stream and exhalation air stream can be separated to avoid inhalation, by the wearer, of the residual warm, humid, and carbon dioxide rich exhaled air trapped inside the interior gas space, whereby face mask 200 is comfortable and hygienic to wear. The first end of separation member 204 is attached onto the inner surface of face piece 202 and the second end thereof extends rearward toward the wearer's facial area in between the nose and mouth, across/around the cheek areas close to the mouth. The second end of separation member 204 is intended to come into contact with and is contoured to conform to the wearer's face.

Separation member 204 is made of a substantially impermeable material, preferably, soft and moisture resistant, e.g., robbers, semi-rigid but flexible silicone hybrid or fluorosilicone materials, foams, papers coated with wax, molded fibers coated with impermeable materials, etc., and any other materials known to those skilled in the art and suggested by this invention disclosure.

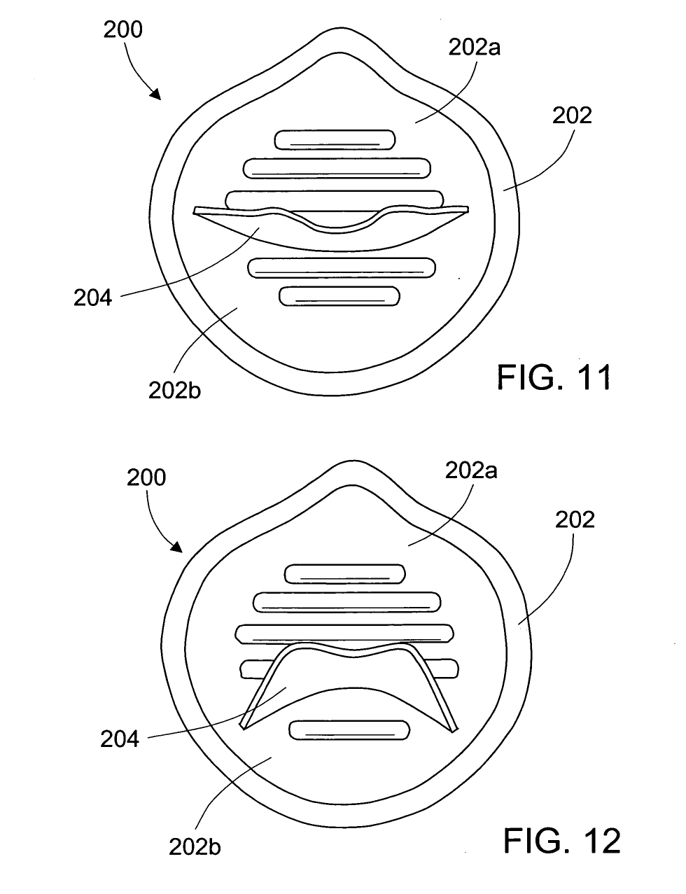

FIG. 11 illustrates a perspective view of face mask 200, viewing from the back indicating a design of separation member 204. Separation member 204 extends substantially across face piece 202 laterally. The middle portion of separation member 204 has a dent feature, which is conformal to the facial area in between the nose and mouth.

FIG. 12 illustrates a perspective view of face mask 200, viewing from the back, indicating an alternative design of separation member 204. The upper portion of separation member 204 forms a semi-cylindrical shape extends substantially around the facial area around the mouth and below the nose. The lower portion thereof extends downward toward the lower edge of face piece 202. The middle portion of separation member 204 has a dent feature, which is conformal to the facial area in between the nose and mouth.

Those skilled in the art will appreciate in view of this invention disclosure, however, that other geometric shapes of separation member 204 could be used for the purpose of substantially dividing face piece 202 into nose portion 202a and mouth portion 202b. For example, separation member 204 can have a closed feature encompassing the mouth of the wearer.

Reference is made to FIG. 9, again. Elastic head band 206 is stapled to face piece 202 at each side to hold face mask 200 against the face of the wearer.

Nose clip 208 is secured on the outer face of face piece 202., adjacent its upper edge, to enable face piece 202 to be shaped in this region to fit to the wearer's nose bridge.

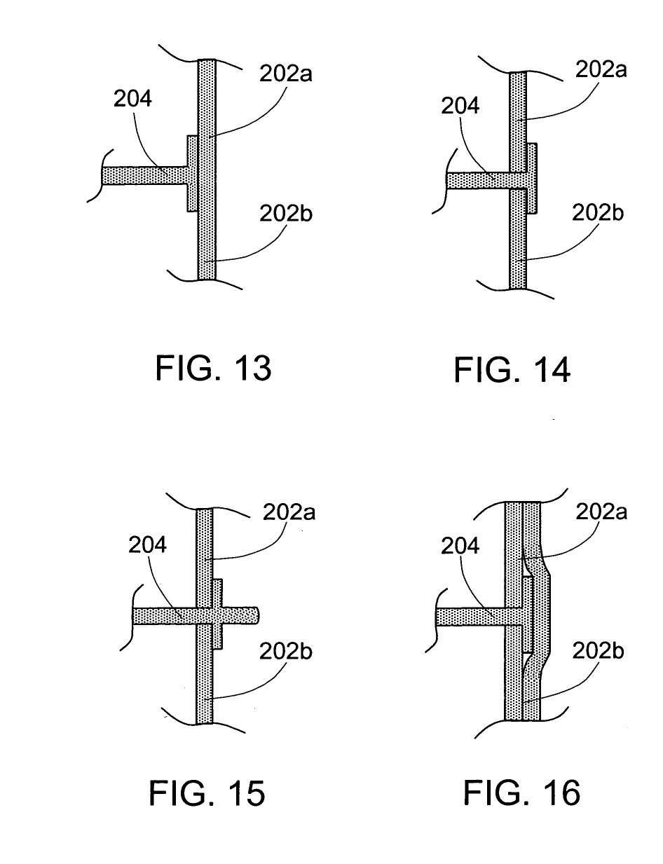

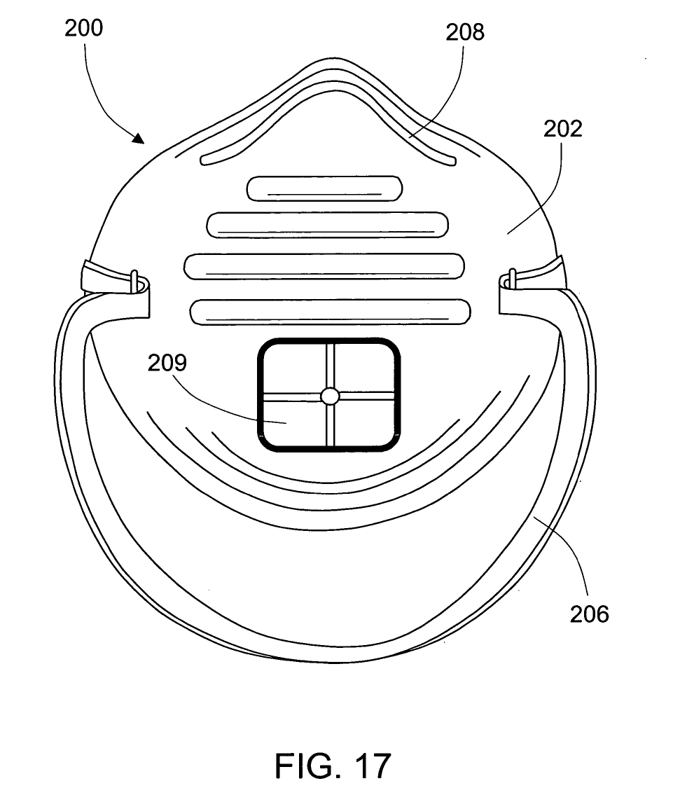

FIGS. 13 through 16 illustrate various methods of attaching separation member 204 onto face piece 202. In FIG. 13, separation member 204 is attached onto the inner surface of face piece 202. In FIG. 14, nose portion 202a and mouth portion 202b are separate parts joining together by separation member 204. In this case, nose portion 202a and mouth portion 202b can be readily made of different materials for optimal filtration material utilization. In FIG. 115, which illustrates a similar design as that in FIG. 14, separation member 204 has a protrusion protruding out of face piece 202 toward the exterior gas space. This protrusion is intended for guiding exhaled air further away from the wearer's face for minimizing the fogging of glasses worn by the wearer. In FIG. 16, face piece 202 has multiple layers. Separation member 204 is separating the inner layers and is covered by the outer layers.

Those skilled in the art will appreciate in view of this invention disclosure that many other methods of attachment are possible and are suggested. Separation member 204 is joined to face piece 202 by such processes as molding, gluing, stitching and other types of joining processes known to those skilled in the art and suggested by this invention disclosure. For example, Separation member 204 can be a detachable/removable part with the first end thereof standing on face piece 202.

FIG. 17 illustrates an alternative design of face mask 200, in which an exhalation device 209 is provided. Exhalation device 209 is installed on the outer surface of face piece 202. Exhalation device 209 comprises a one-way valve for allowing exhaled air to be purged from the interior gas space more easily. Exhalation device 209 can further includes a filtration material, as known in prior arts, whereby face mask 200 can protect other persons or things from being exposed to contaminants expelled by the wearer, as compared with the valve-only design. This design can have medical, clean room, and many other applications. Reference is directed to previous discussion for detailed structures of the one-way valve and filtration material.

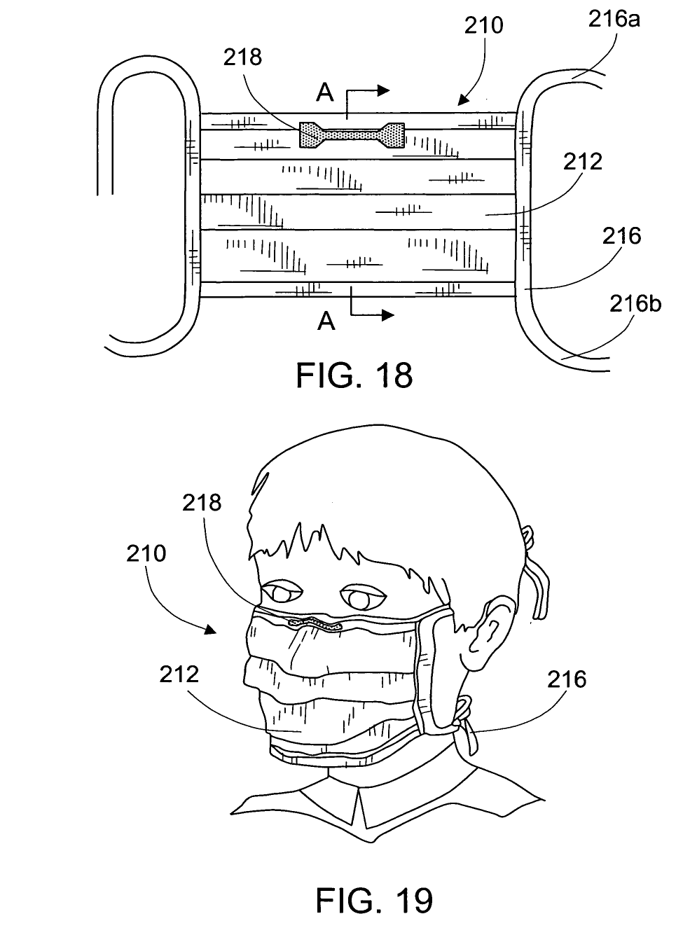

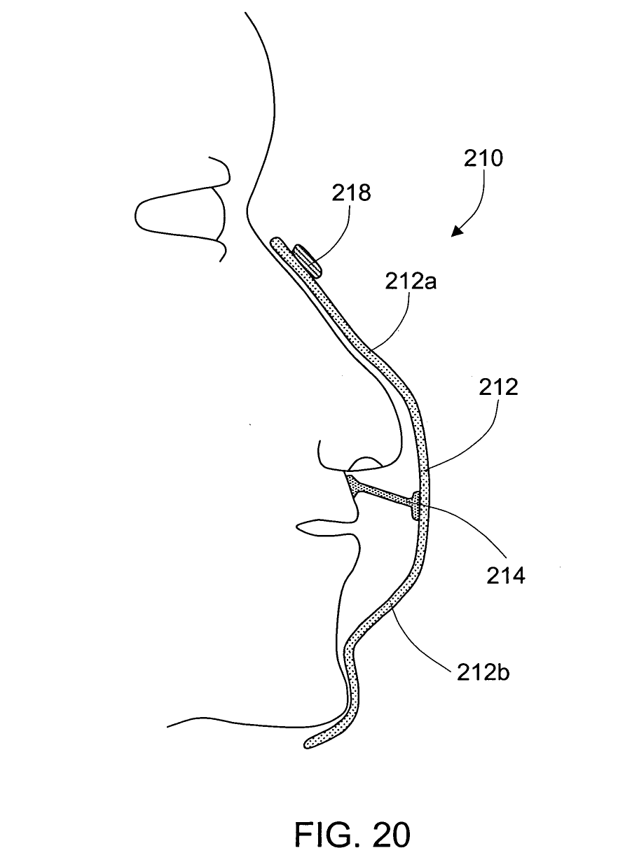

Reference is made to FIGS. 18 through 20, which illustrate a further more embodiment of the present invention, a fold flat face mask 210. FIG. 18 illustrates a front view of face mask 210. FIG. 19 illustrates a perspective view of face mask 210 on a wearer. FIG. 20 shows a cross-sectional view of face mask 20, taken along line A-A of FIG. 18, as worn by a wearer.

Face mask 210 includes a face piece 212, a separation member 214, a plurality of fasteners 216, and a nose clip 218.

Face piece 212 has a plurality of folds, which enable face piece 212 to extend outward over the contours of the wearer's face, and is designed to cover the nose and mouth of the wearer. Face piece 212 is made of one or multiple layers of air-permeable filtration materials.

Separation member 214 substantially divides face piece 212 into a nose portion 212a and a mouth portion 212b, thereby, forming a nose chamber and a mouth chamber, such that the gas communication between the two chambers is minimized and such that inhalation air stream and exhalation air stream can be separated to avoid inhalation, by the wearer, of the residual warm, humid, and carbon dioxide rich exhaled air trapped inside the interior gas space, whereby face mask 210 is comfortable and hygienic to wear. The first end of separation member 214 is attached onto face piece 212 and the second end thereof extends rearward toward the wearer's facial area in between the nose and mouth, across/around the cheek areas close to the mouth. The second end of separation member 214 is intended to come into contact with and is contoured to conform to the wearer's face.

Separation member 214 is made of a substantially impermeable material, preferably, soft and moisture resistant, e.g., robbers, semi-rigid but flexible silicone hybrid or fluorosilicone materials, foams, papers coated with wax, molded fibers coated with impermeable materials, etc., and other materials known to those skilled in the art and suggested by this invention disclosure.

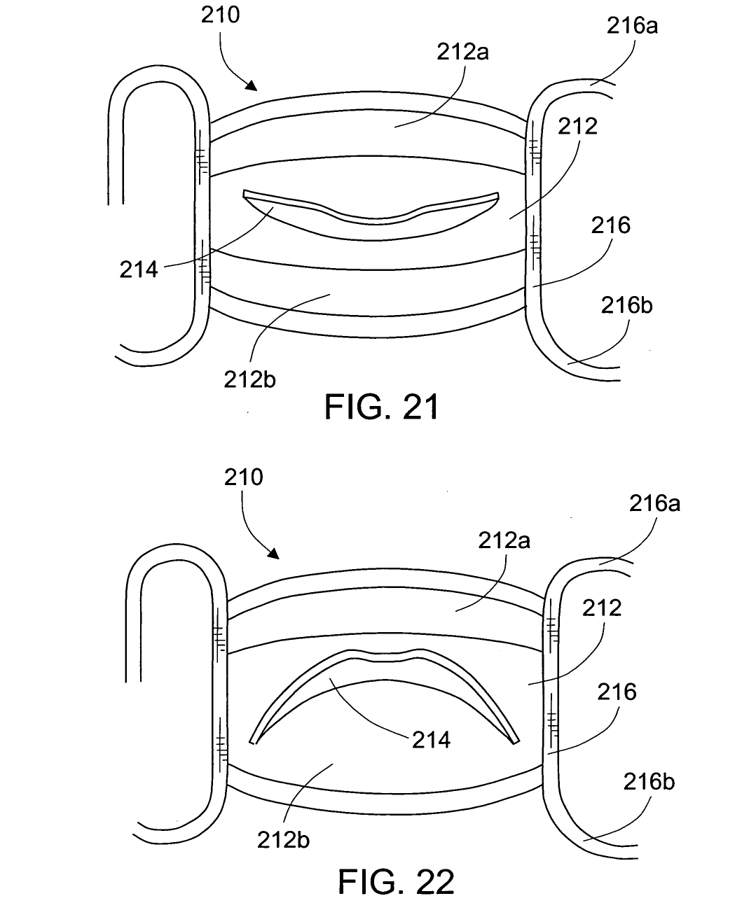

FIGS. 21 and 22 illustrate perspective views of separation member 214, viewing from the back, indicating two different designs of separation member 214. The attachment of separation member 214 onto face piece 212 and other features are similar to those for molded face mask 200 discussed previously. Therefore, reference is directed to the discussion of face mask 200, in FIGS. 9 through 17 for detailed information.

One advantage worth mentioning about face mask 210 of the present invention is that, properly designed, separation member 214 will help face piece 210 form a cup-shaped, face-fitting configuration, such that face piece 212 does not come into direct contact with the facial area around the nose and mouth. This further improves the comfort level of wearing face mask 210, compared with prior art products. In this case, face mask 210 is functioning similar to molded face mask 200. Therefore, exhalation valves (not shown) can be provided for facilitating the purging of exhaled air. Reference is directed to the discussion of face mask 200 in FIGS. 9 through 17 for detailed information.

Reference is made to FIGS. 18 and 19, again. Fasteners 216 are provided to secure face mask 210 over the face of the wearer. In the illustrated embodiment, fasteners 216 include an upper pair of tie straps 216a and a lower pair of tie straps 216b that extend from top edge and bottom edge of mask 210, respectively. When mask 210 is worn, tie straps 216a and 216b are secured around the head and the neck of the wearer.

Nose clip 218 is secured on the outer face of face piece 212, adjacent its upper edge, to enable face piece 212 to be shaped in this region to fit to the wearer's nose bridge.

In the case of a face mask in which the filtration material is made of multi-layers of meshed fabrics, reference is made to the discussion of fold flat face mask 210 described previously, in FIGS. 18 through 22 for detailed information.

In operation, a method of using the face mask of the present invention comprising the steps of:

1) providing a face mask comprising a face piece for covering at least the nose and mouth of a wearer, and a separation member, made of a substantially impermeable material, substantially dividing the face piece into a nose portion and a mouth portion, thereby forming a nose chamber and a mouth chamber, such that the gas communication between the nose chamber and the mouth chamber is minimized, having a first end attached onto the face piece and a second end extending rearward toward the facial area in between the nose and mouth of the wearer and the cheek areas around the mouth, such that the second end of the separation member is conformal to the wearer's face around the mouth;

2) fastening the face mask onto the wearer's face, such that the nose portion is covering the nose area and the mouth portion is covering the mouth area, and such that the separation member is disposed in between the nose and mouth of the wearer;

3) inhaling with the nose; and

4) exhaling with the mouth; and

whereby the exhaled air is directed out of the interior gas space through mouth portion and the re-inhalation of residual exhaled air is totally eliminated and the fogging of eyeglasses is substantially minimized.

Accordingly, readers will see that this face mask of the present invention can be used for various applications. This face mask has a separation member, made of a substantially impermeable material, substantially dividing the face piece into a nose portion and a mouth portion, thereby forming a nose chamber and a mouth chamber, such that the gas communication between the two chambers is minimized and such that inhalation air stream and exhalation air stream can be separated to avoid inhalation, by the wearer, of the residual warm, humid, and carbon dioxide rich exhaled air trapped inside the interior gas space and within the filtration materials, whereby the face mask is comfortable and hygienic to wear. This face mask is beneficial to the people who wear glasses, as well, because the fogging of glasses is minimized due to directing the exhaled humid air downward through the mouth chamber. This face mask of the present invention is especially beneficial to those who have to wear a face mask for a pro-longed period of time, such as clean-room workers, operation-room doctors and nurses, patients suffering from extremely contagious respiratory diseases, like SARS, firefighters in fighting fire disasters, soldiers in chemical and biological battle fields, etc.

The present invention has been described in an illustrative manner. It is to be understood that the terminology, which has been used, is intended to be in the nature of words of description rather than of limitation.

Although the invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

1. A face mask for a wearer, said face mask comprising:
an outer face piece covering at least the nose, mouth, and eyes of said wearer;
an inner face piece covering the nose and mouth of said wearer installed inside said outer face piece;
a separation piece substantially dividing said inner face piece into a nose portion and a mouth portion, thereby, forming a nose chamber and a mouth chamber, and having a first end attached to said inner face piece and a second end extending rearward toward the facial area of said wearer in between the nose and mouth;
an exhalation device installed on said outer face piece for allowing exhaled air to pass therethrough from an interior gas space to an exterior gas space;
an inhalation device installed on said outer face piece for allowing air to pass therethrough from an exterior gas space to an interior gas space; and
lens means connected to said outer face piece.

2. A face mask as defined in claim 1, wherein said separation piece is made of a substantially impermeable material.

3. A face mask as defined in claim 1, wherein said exhalation device includes a one-way valve for allowing exhaled air to pass therethrough from an interior gas space to an exterior gas space.

4. A face mask as defined in claim 1, wherein said exhalation device includes filter means for filtering the air passing therethrough.

5. A face mask as defined in claim 1, wherein said inhalation device includes filter means for filtering the air passing therethrough.

6. A face mask as defined in claim 5, wherein said inhalation device includes a one-way valve for preventing exhaled air from passing therethrough.

7. A face mask for a wearer, said face mask comprising:
a face piece covering at least the nose and mouth of said wearer; and
a separation member substantially dividing said face piece into a nose portion and a mouth portion, thereby forming a nose chamber and a mouth chamber, and having a first end attached to said face piece and a second end extending rearward toward the facial area of said wearer in between the nose and mouth.

8. A face mask as defined in claim 7, wherein said separation member is made of a substantially impermeable material.

9. A face mask as defined in claim 8, said face mask further including:
an exhalation device installed on said face piece for allowing exhaled air to pass therethrough from an interior gas space to an exterior gas space; and
an inhalation device installed on said face piece for allowing air to pass therethrough from an exterior gas space to an interior gas space.

10. A face mask as defined in claim 9, wherein said exhalation device includes a one-way valve for allowing exhaled air to pass therethrough from an interior gas space to an exterior gas space.

11. A face mask as defined in claim 9, wherein said exhalation device includes filter means for filtering the air passing therethrough.

12. A face mask as defined in claim 9, wherein said inhalation device includes filter means for filtering the air passing therethrough.

13. A face mask as defined in claim 12, wherein said inhalation device includes a one-way valve for preventing exhaled air from passing therethrough.

14. A face mask as defined in claim 8, wherein said face piece is made of a filtration material.

15. A face mask as defined in claim 14, wherein said face piece is a molded face piece having a cup-shaped shape-retaining layer.

16. A face mask as defined in claim 15, said face mask further including an exhalation device installed on said face piece for allowing exhaled air to pass therethrough from an interior gas space to an exterior gas space.

17. A face mask as defined in claim 16, wherein said exhalation device includes a one-way valve for allowing exhaled air to pass therethrough from an interior gas space to an exterior gas space.

18. A face mask as defined in claim 16, wherein said exhalation device includes filter means for filtering the air passing therethrough.

19. A face mask as defined in claim 14, wherein said face piece is a flat face piece.

20. A method for using a face mask, said method comprising the steps of:
providing said face mask comprising a face piece for covering at least the nose and mouth of a wearer, a separation member, made of a substantially impermeable material, substantially dividing said face piece into a nose portion and a mouth portion, thereby forming a nose chamber and a mouth chamber, and having a first end attached to said face piece and a second end extending rearward toward the facial area of said wearer in between the nose and mouth, such that the second end of said separation member is conformal to the face of said wearer;
fastening said face mask onto the face of said wearer, such that said nose portion is covering the nose area and said mouth portion is covering the mouth area, and such that said separation member is disposed in between the nose and mouth of said wearer;
inhaling with the nose; and
exhaling with the mouth; and
whereby the exhaled air is directed out of the interior gas space through said mouth portion, the re-inhalation of residual exhaled air is totally eliminated, and the fogging of eyeglasses is minimized.
